(19) United States
(12) Patent Application Publication
(10) Pub. No.: US 2008/0019295 A1
(43) Pub. Date: Jan. 24, 2008

(54) POWER SAVING SYSTEM AND METHOD FOR WIRELESS COMMUNICATION SYSTEM

(75) Inventor: CHENG-WEN TANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/766,111

(22) Filed: Jun. 21, 2007

(30) Foreign Application Priority Data
Jul. 21, 2006 (TW) 095126676

(51) Int. Cl. H04Q 7/20

(52) U.S. Cl. 370/311; 370/338

(57) ABSTRACT

A power saving method applied in a wireless local area network (WLAN) includes an access point and at least one mobile station. The power saving method includes the following steps. The power saving method includes the following steps. One of the at least one mobile station enters an active mode, and sends a query frame to the access point. The access point sends an acknowledgement frame to the one of the at least one mobile station after receiving the query frame and begins timing via a timing module. The access point determines whether there is a data frame to be sent to the one of the at least one mobile station. The access point sends the data frame to the one of the at least one mobile station when the timing module times out if there is the data frame to be sent to the one of the at least one mobile station. The one of the at least one mobile station enters a power saving mode after receiving the data frame.

### BACKGROUND

1. Field of the Invention

The present invention generally relates to wireless communication systems, and more particularly to a power saving system and method in a wireless communication system.

2. Related Art

In a wireless local area network (WLAN), power consumption is an important consideration for network devices therein, such as mobile stations. Nowadays, most mobile stations support a power saving mode (PSM) defined in the 802.11 WLAN protocol by the Institute of Electrical and Electronics Engineers (IEEE), and the mobile stations supporting the PSM can function longer than those not supporting the PSM.

A mobile station in the PSM periodically enters an active mode, and sends a quality of service poll (QoS-Poll) frame to an access point to check whether there is a data frame in the access point to be sent to the mobile station. After receiving the QoS-Poll frame, the access point sends an acknowledgement frame to the mobile station. If there is the data frame in the access point to be sent to the mobile station, the access point sends the data frame to the mobile station after a variable time period. If no data frame in the access point is to be sent to the mobile station, the access point sends a frame indicating so after another variable time period. In the IEEE 802.11 protocol, the variable time periods are not definitely defined, and the variable time periods are usually longer than a point coordination function inter-frame space (PIFS). In this way, the mobile station cannot turn back to the PSM in a shortest time period, which accordingly increases power consumption of the mobile station. Besides, a hacker may have a chance during such a long time period to send false information to the mobile station so as to interrupt data communication between the mobile station and the access point or intercept data transmitted between the mobile station and the access point. Data needed to transmit to the mobile station from the access point may be lost due to such an unexpected interruption.

Therefore, a heretofore unaddressed need exists in the industry to overcome the aforementioned deficiencies and inadequacies.

### SUMMARY

In an exemplary embodiment, a power saving system is applied in a wireless local area network (WLAN) including an access point and at least one mobile station. The power saving system includes a first sending module, a second sending module, a judging module, and a timing module. The first sending module configured in the at least one mobile station sends a query frame to the access point when the at least one mobile station enters an active mode. The second sending module configured in the access point sends an acknowledgement frame to one of the at least one mobile station after the access point receives the query frame. The judging module configured in the access point determines whether there is a data frame in the access point to be sent to the one of the at least one mobile station when the access point receives the query frame. The timing module configured in the access point begins timing when the second sending module sends the acknowledgement frame to the one of the at least one mobile station. Wherein if there is the data frame in the access point to be sent to the one of the at least one mobile station, the second sending module sends the data frame to the one of the at least one mobile station when the timing module times out.

Another exemplary embodiment provides a power saving method applied in a wireless local area network (WLAN) including an access point and at least one mobile station. The power saving method includes the following steps. One of the at least one mobile station enters an active mode, and sends a query frame to the access point. The access point sends an acknowledgement frame to the one of the at least one mobile station after receiving the query frame and begins timing via a timing module. The access point determines whether there is a data frame to be sent to the one of the at least one mobile station. The access point sends the data frame to the one of the at least one mobile station when the timing module times out if there is the data frame to be sent to the one of the at least one mobile station. The one of the at least one mobile station enters a power saving mode after receiving the data frame.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram illustrating an application environment of a power saving system in accordance with an exemplary embodiment of the invention, the power saving system including an access point and a plurality of mobile stations;

FIG. 2 is a schematic diagram showing functional modules of the access point and one of the mobile stations of FIG. 1;

FIG. 3 is a schematic diagram of a quality of service null (QoS-Null) frame sent from an access point to the one of the mobile stations in FIG. 1; and

FIG. 4 is a flowchart of a power saving method in accordance with another exemplary embodiment of the invention.

### DETAILED DESCRIPTION OF THE EMBODIMENTS

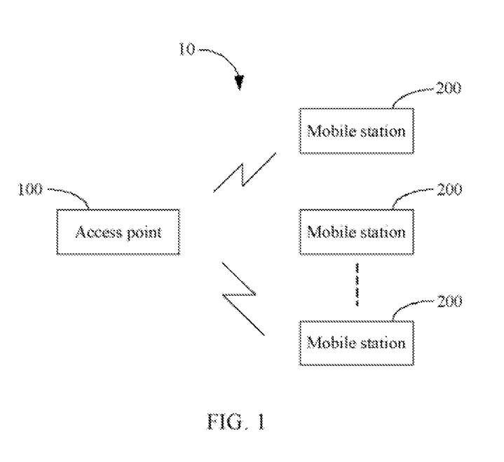

FIG. 1 is a schematic diagram illustrating an application environment of a power saving system 1 0 in accordance with an exemplary embodiment.

In this embodiment, the power saving system 10 is applied in a wireless local area network (WLAN). The WLAN includes an access point 100 and at least one mobile station 200. The access point 100 communicates with the at least one mobile station 200 according to the Institute of Electrical and Electronics Engineers (IEEE) 802.11 WLAN protocol. The at least one mobile station 200 may be a laptop computer, a Personal Digital Assistant (PDAs), or a mobile phone, etc. In the following embodiments description is simplified by referring to one mobile station although it is to be understood that the embodiments may apply to many mobile stations.

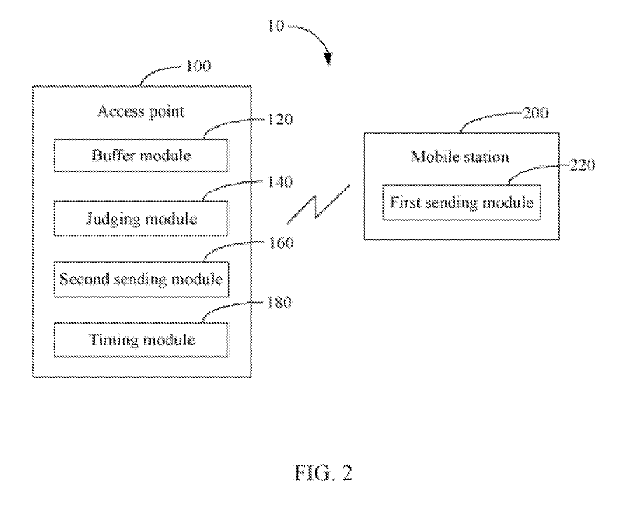

FIG. 2 is a schematic diagram showing functional modules of the power saving system 10 in accordance with another exemplary embodiment of the invention. The power saving system 10 includes a buffer module 120, a judging module 140, a second sending module 160, a timing module 180, and a first sending module 220. In the preferred embodiment, the buffer module 120, the judging module 140, the second sending module 160, and the timing module 180 are configured in the access point 100. The first sending module 220 is configured in the mobile station 200.

The buffer module 1 20 provisionally stores a data frame to be sent to the mobile station 200 when the mobile station 200 is in a power saving mode (PSM).

The first sending module 220 sends a query frame to the access point 100 when the mobile station 200 enters an active mode from the PSM.

In this embodiment, the query frame is a quality of service poll (QoS-Poll) frame. The mobile station 200 enters the active mode and sends the QoS-Poll frame to the access point 100 periodically, such as every 5 seconds, to inform the access point 100 that the mobile station 200 can receive the data frame. The access point 100 sends an acknowledgment frame to the mobile station 200 after receiving the QoS-Poll frame.

The judging module 140 determines whether there is the data frame in the access point 100 to be sent to the mobile station 200 when the access point 100 receives the query frame. In this embodiment, the judging module 140 compares a destination media access control (MAC) address of the data frame stored in the buffer module 120 with a MAC address of the mobile station 200. If the destination MAC address of the data frame buffered in the buffer module 120 is the same as that of the mobile station 200, the judging module 140 determines that there is the data frame in the access point 100 to be sent to the mobile station 200. If the destination MAC address of the data frame stored in the buffer module 120 is not the same as the MAC address of the mobile station 200, the judging module 140 determines that there is no data frame in the buffer module 120 to be sent to the mobile station 200.

The second sending module 1 60 sends an acknowledgement frame to the mobile station 200 after the access point 100 receives the query frame.

The timing module 1 80 begins timing when the second sending module 160 sends the acknowledgement frame to the mobile station 200. When the timing module 180 times out, the access point 100 sends the data frame to the mobile station 200.

In this embodiment, a time period of the timing module 180 is equal to a point coordination function inter-frame space (PIFS). The access point 100 needs to wait for the time period before sending the data frame to the mobile station 200. The PIFS is the shortest time period that the access point 100 needs to wait before sending the data frame to the mobile station 200. If there is the data frame to be sent to the mobile station 200, the access point 100 sends the acknowledgement frame to the mobile station 200, and then sends the data frame to the mobile station 200 when the timing module 180 times out. After receiving the data frame, the mobile station 200 enters the PSM, thus reducing time spent in the active mode.

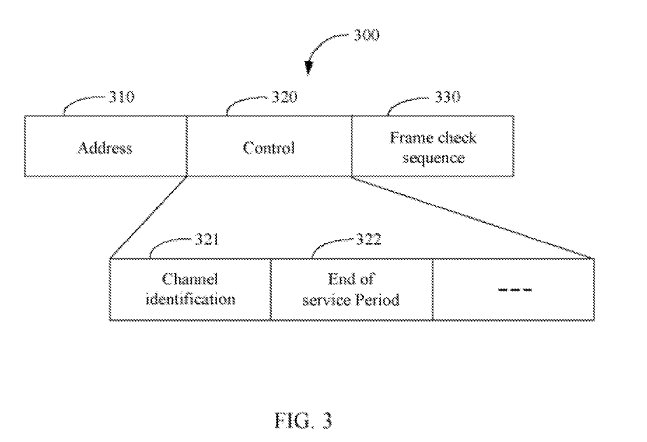

If there is no data frame in the buffer module 120 to be sent to the mobile station 200, the access point 100 sends a response frame to the mobile station 200 when the timing module 180 times out. The response frame indicates that there is no data frame to be sent to the mobile station 200. The mobile station 200 enters the PSM after receiving the response frame. The response frame is a quality of service null (QoS-Null) frame, and a format of the QoS-Null frame is shown in FIG. 3.

FIG. 3 is a schematic diagram of the QoS-Null frame 300 sent from the access point 100 to the mobile station 200.

In this embodiment, the QoS-Null frame 300 includes an address field 310, a control field 320, and a frame check sequence (FCS) field 330. The control field 320 includes a channel identification subfield 321 and an end of service period (EOSP) subfield 322. The EOSP subfield 322 is used for indicating whether there is a data frame to be sent to the mobile station 200. In this embodiment, a value of the EOSP subfield 322 is set to 1 when the access point 100 does not have the data frame to be sent to the mobile station 200. The value of the EOSP subfield 322 is set to 0 when the access point 100 does have the data frame to be sent to the mobile station 200.

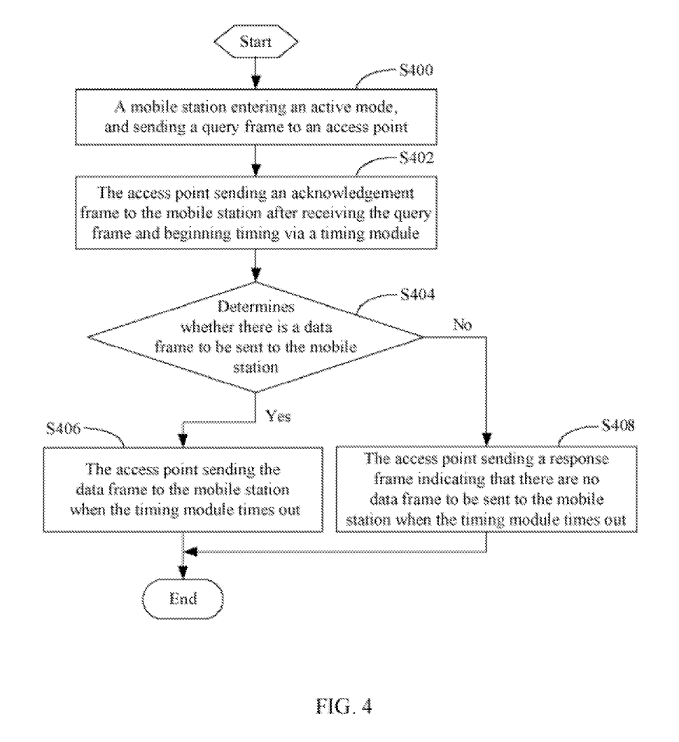

FIG. 4 is a flowchart of a power saving method in accordance with another exemplary embodiment of the invention.

In step S400, the mobile station 200 enters an active mode, and sends a query frame to the access point 100. In this embodiment, in order to reduce power consumption of the mobile station 200, the mobile station 200 stays in the PSM when not sending and receiving frames or standing by during the time period. The query frame is a QoS-Poll frame. During a time the mobile station 200 is in the PSM, the access point 100 stores the data frame destined for the mobile station 200 in the buffer module 120. The mobile station 200 sends the QoS-Poll frame to the access point 100 after entering the active mode, to inform the access point 100 that the mobile station 200 can receive the data frame.

In step S402, the access point 100 sends an acknowledgement frame to the mobile station 200 after receiving the query frame, and begins timing via the timing module 180. In this embodiment, the access point 100 informs the mobile station 200 that the access point 100 has received the QoS-Poll frame by sending the acknowledgement frame.

In step S404, the access point 100 determines whether there is the data frame to be sent to the mobile station 200.

In this embodiment, the judging module 140 compares the destination MAC address of the data frame stored in the buffer module 120 with the MAC address of the mobile station 200. If the destination MAC address of the data frame stored in the buffer module 120 is the same as the MAC address of the mobile station 200, the judging module 140 determines that there is the data frame in the access point 100 to be sent to the mobile station 200. If the destination MAC address of the data frame stored in the buffer module 120 is not the same as the MAC address of the mobile station 200, the judging module 140 determines that there is no data frame in the buffer module 120 to be sent to the mobile station 200.

If there is the data frame to be sent to the mobile station 200, in step S406, the access point 100 sends the data frame to the mobile station 200 when the timing module 180 times out. In this embodiment, a time period of the timing module 180 is equal to the PIFS. After the mobile station 200 receives the data frame, it enters its power saving mode for power saving purpose.

If there is no data frame in the access point 100 to be sent to the mobile station 200, in step S408, the access point 100 sends a response frame to the mobile station 200 when the timing module 180 times out. After the mobile station 200 receives the response frame, it enters its power saving mode for power saving purpose. In this embodiment, since the time period of the timing module 180 is equal to the PIFS, the waiting time of the mobile station 200 switching to the PSM is reduced, and thereby power consumption of the mobile station 200 is reduced.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A power saving system applied in a wireless local area network (WLAN) comprising an access point and at least one mobile station, the power saving system comprising:
a first sending module configured in the at least one mobile station, for sending a query frame to the access point when the at least one mobile station enters an active mode;
a second sending module configured in the access point, for sending an acknowledgement frame to one of the at least one mobile station after the access point receives the query frame;
a judging module configured in the access point, for determining whether there is a data frame in the access point to be sent to the one of the at least one mobile station when the access point receives the query frame; and
a timing module configured in the access point, for beginning timing when the second sending module sends the acknowledgement frame to the one of the at least one mobile station;
wherein if there is the data frame in the access point to be sent to the one of the at least one mobile station, the second sending module sends the data frame to the one of the at least one mobile station when the timing module times out.

2. The power saving system as recited in claim 1, wherein the access point communicates with the at least one mobile station according to the Institute of Electrical and Electronics Engineers (IEEE) 802.11 protocol.

3. The power saving system as recited in claim 1, wherein the timing module is further used for timing after the access point sends the acknowledgement frame to the one of the at least one mobile station, in order that the access point sends a frame indicating there are no data frames to be sent to the one of the at least one mobile station when the timing module times out.

4. The power saving system as recited in claim 1, further comprising a buffer module configured in the access point, for buffering the data frame to be sent to the one of the at least one mobile station.

5. The power saving system as recited in claim 1, wherein the time period of the timing module is equal to a point coordination function inter-frame space.

6. The power saving system as recited in claim 1, wherein the judging module determines whether there is the data frame in the access point to be sent to the one of the at least one mobile station by comparing destination media access control (MAC) address of the data frame buffered in the access point with a MAC address of the one of the at least one mobile station.

7. A power saving method applied in a wireless local area network (WLAN) comprising an access point and at least one mobile station, the power saving method comprising:
one of the at least one mobile station entering an active mode, and sending a query frame to the access point;
the access point sending an acknowledgement frame to the one of the at least one mobile station after receiving the query frame and beginning timing via a timing module;
the access point determining whether there is a data frame to be sent to the one of the at least one mobile station;
the access point sending the data frame to the one of the at least one mobile station when the timing module times out if there is the data frame to be sent to the one of the at least one mobile station; and
the one of the at least one mobile station entering a power saving mode after receiving the data frame.

8. The power saving method as recited in claim 7, wherein the query frame is a quality of service poll frame.

9. The power saving method as recited in claim 7, further comprising the step of:
the access point sending a response frame indicating that there is no data frame to be sent to the one of the at least one mobile station, if there is no data frame, when the timing module times out.

10. The power saving method as recited in claim 9, wherein the response frame is a quality of service null frame.

11. The power saving method as recited in claim 10, wherein the time period of the timing module is equal to a point coordination function inter-frame space.

12. A method for power saving in a mobile station data communicable with an access point, comprising steps of:
sending a query frame to an access point from a mobile station data communicable with said access point when said mobile station enters an active mode of said mobile station from a power saving mode thereof;
starting timing in said access point after said access point receives said query frame and sends an acknowledgement frame to said mobile station for acknowledging receipt of said query frame;
sending a data-related frame from said access point to said mobile station after said timing in said access point expires; and
switching said mobile station from said active mode thereof to said power saving mode thereof after said mobile station receives said data-related frame.

13. The method as recited in claim 12, wherein said data-related frame is a selective one of a data frame when said data frame is ready in said access point to send to said mobile station, and a response frame when said data frame is not available in said access point.
